(19) United States
(12) Patent Application Publication
(10) Pub. No.: US 2009/0157295 A1
(43) Pub. Date: Jun. 18, 2009

(54) Navigation Apparatus

(75) Inventors: Katsuya Asada, Zama-shi (JP); Noriyuki Abe, Yokohama-shi (JP); Yuta Kobayashi, Sagamihara-shi (JP); Shigeru Shimada, Tokyo (JP); Kishiko Maruyama, Tokyo (JP); Akinori Asahara, Tokyo (JP)

Correspondence Address: CROWELL & MORING LLP;INTELLECTUAL PROPERTY GROUP, P.O. BOX 14300, WASHINGTON, DC, 20044-4300, US

(73) Assignee: Xanavi Informatics Corporation, Zama-shi (JP)

(21) Appl. No.: 12/332,738

(22) Filed: Dec. 11, 2008

(30) Foreign Application Priority Data
Dec. 12, 2007 (JP) 2007-320591

(51) Int. Cl. G01C 21/36; G06F 3/048

(52) U.S. Cl. 701/200; 715/764

(57) ABSTRACT

A navigation apparatus comprises a route setting unit that sets a route, a route characteristic point setting unit that sets a plurality of route characteristic points to the route set by the route setting unit, a priority setting unit that sets priority to each of the route characteristic points set by the route characteristic point setting unit, a selecting unit that selects any of the route characteristic points based upon the priority set by the priority setting unit, and a display control unit that displays the route and the route characteristic point selected by the selecting unit on a display monitor.

### INCORPORATION BY REFERENCE

The disclosure of the following priority application is herein incorporated by reference: Japanese Patent Application No. 2007-320591 filed Dec. 12, 2007

### BACKGROUND OF THE INVENTION

1. Field of the Invention

The present invention relates to a navigation apparatus.

2. Description of Related Art

Japanese Laid-Open Patent Application No. 2006-162503 discloses a navigation apparatus that searches a plurality of routes and displays differences among them and characteristics of them in a comprehensible manner. This navigation apparatus sets a point at which a plurality of routes branch off and a point at which either road name or road category of a route changes as a route characteristic point, and displays the point with a route characteristic point mark which is put to it.

In the known navigation apparatus, when a multitude of route characteristic points exist, a multitude of route characteristic point marks are displayed on a screen accordingly. This often makes characteristics of each of the routes rather incomprehensible.

### SUMMARY OF THE INVENTION

A navigation apparatus according to a first aspect of the present invention comprises a route setting unit that sets a route, a route characteristic point setting unit that sets a plurality of route characteristic points to the route set by the route setting unit, a priority setting unit that sets priority to each of the route characteristic points set by the route characteristic point setting unit, a selecting unit that selects any of the route characteristic points based upon the priority set by the priority setting unit, and a display control unit that displays the route and the route characteristic point selected by the selecting unit on a display monitor.

According to a second aspect of the present invention, in the navigation apparatus of the first aspect, the selecting unit may select a route characteristic point to which priority with a predetermined threshold or higher is set.

According to a third aspect of the present invention, it is preferable that the navigation apparatus of the second aspect further comprises a changing unit that changes the threshold according to an operation by a user.

According to a fourth aspect of the present invention, it is desirable that the navigation apparatus of the third aspect further comprises an operation member that can be operated in a rotating or a sliding manner. In this navigation apparatus, the changing unit may change the threshold according to an operation amount of the operation member by the user.

According to a fifth aspect of the present invention, in the navigation apparatus of the first aspect, the selecting unit can select route characteristic points in descending order of priority as long as the total number of selected route characteristic points is within a predetermined display limit number.

According to a sixth aspect of the present invention, it is preferable that the navigation apparatus of the fifth aspect further comprises a changing unit that changes the display limit number according to an operation by a user.

According to a seventh aspect of the present invention, it is desirable that the navigation apparatus of the sixth aspect further comprises an operation member that can be operated in a rotating or a sliding manner. In this navigation apparatus, the changing unit may change the display limit number according to an operation amount of the operation member by the user.

According to a eighth aspect of the present invention, in the navigation apparatus according to any one of the first through seventh aspects, it is preferable that the route characteristic point setting unit sets points upon the route or points along the route as the route characteristic points.

According to a ninth aspect of the present invention, in the navigation apparatus of the eighth aspect, the route setting unit may set a plurality of routes, and the route characteristic point setting unit may set, among the points upon the routes, at least one of a branch point at which a road branches into a plurality of the routes, a confluence point at which a plurality of the routes merge into one road, a road category change point at which a road category of the route changes, an intersection on the route, and an interchange on the route, as the route characteristic point.

According to a tenth aspect of the present invention, in the navigation apparatus of the eighth aspect, the route characteristic point setting unit may set, among the points along the route, a facility located along the route as the route characteristic point.

According to an eleventh aspect of the present invention, in the navigation apparatus of any one of the first through tenth aspects, it is desirable that the priority setting unit sets the priority based upon a road category of the route at the route characteristic point or based upon a positional relationship between a start point or an end point of the route and the route characteristic point.

According to a twelfth aspect of the present invention, the navigation apparatus of any one of the first through eleventh aspects, the display control unit may display an abridged map in which a shape of the route is simplified on the display monitor.

A navigation apparatus according to a thirteenth aspect of the present invention comprises a route setting unit that sets a route, a route characteristic point setting unit that sets a facility located along the route as a route characteristic point to the route, and a display control unit that displays the route and the route characteristic point on a display monitor.

### BRIEF DESCRIPTION OF THE DRAWINGS

FIG. 1 is a block diagram showing the structure of a navigation apparatus according to an embodiment of the present invention.

FIG. 2 is a flow chart of a procedure which is executed when searching for a plurality of routes to a destination which has been set, and displaying an abridged map of these routes.

FIGS. 3A, 3B, 3C, and 3D are figures for explanation of the details of a direction quantization procedure for the case of division into two sections, which is taken advantage of when generating the abridged map.

FIGS. 4A, 4B, 4C, and 4D are figures for explanation of the details of a direction quantization procedure for the case of division into four sections.

FIGS. 5A, 5B, and 5C are figures for explanation of a method for simplifying the road shapes of routes by approximating each of the link shapes with a curve.

FIG. 6A is a figure showing links, nodes, and shape interpolation points before the direction quantization procedure for the case of division into four sections is performed. FIG. 6B is a figure showing links, nodes, and shape interpolation points after the direction quantization procedure for the case of division into four sections is performed.

FIGS. 7A, 7B, and 7C are figures for explanation of data formats for storing routes on which the direction quantization procedure is performed in a RAM.

FIG. 8 is a figure showing an example of priority which is set according to road categories of routes.

FIG. 9 is a figure showing an example of an all-routes display screen.

FIG. 10 is a figure showing an example of an all-routes display screen with the number of route characteristic points smaller than that of FIG. 9 displayed.

FIG. 11 is a figure showing an example of an all-routes display screen with the number of the route characteristic points smaller than that of FIG. 10 displayed.

FIG. 12 is a figure showing an example of an all-routes display screen with none of the route characteristic points displayed.

FIG. 13 is a figure showing a display screen of the navigation apparatus when a route selection button is selected.

FIG. 14 is a figure showing a display screen of the navigation apparatus when a waypoint button is selected.

### DESCRIPTION OF PREFERRED EMBODIMENTS

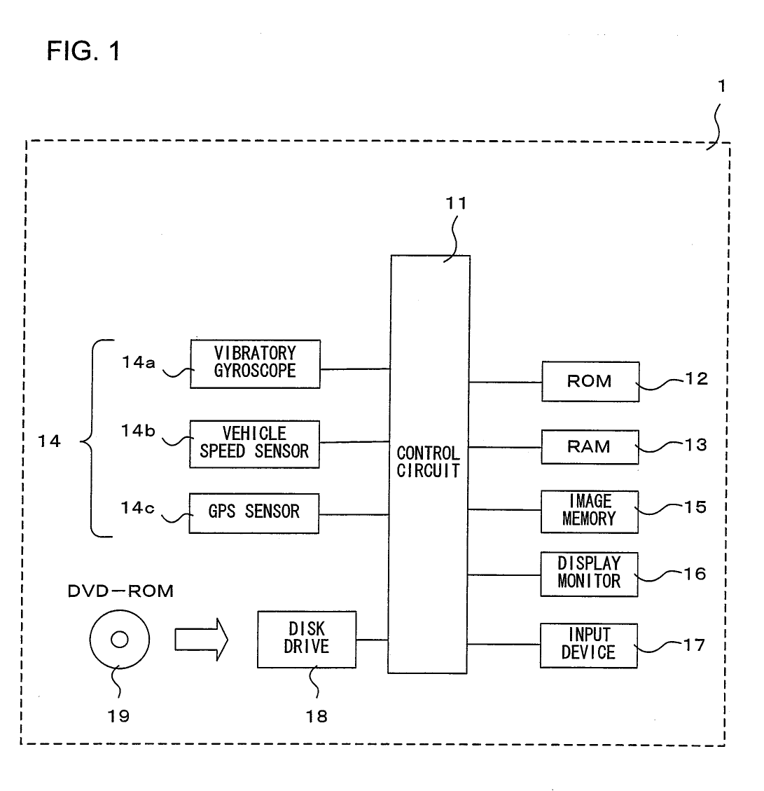

The structure of the navigation apparatus according to an embodiment of the present invention is shown in FIG. 1. This navigation apparatus is mounted to a vehicle, and it searches out a plurality of routes to a destination which has been set, and generates and displays a map which has been abridged from a normal map (hereinafter termed an abridged map) by, for the entirety of each route, simplifying the road shapes and the like based upon the normal map. And one among the plurality of routes which have been displayed is selected by the user, and the vehicle is guided to the destination by taking this route as the recommended route. It should be understood that the abridged map is a collective term for maps that show road shapes changed by performing a direction quantization procedure, a curve approximation procedure, or the like on road shape data of map data. The abridged map will be explained in detail hereinafter.

The navigation apparatus shown in FIG. 1 comprises a control circuit 11, a ROM 12, a RAM 13, a current position detection device 14, an image memory 15, a display monitor 16, an input device 17, and a disk drive 18. A DVD-ROM 19 upon which map data is recorded is loaded in the disk drive 18.

The control circuit 11 consists of a microprocessor and its peripheral circuitry, and, using the RAM 13 as a work area, it performs various types of procedures and controls by executing a control program which is stored in the ROM 12. By procedures which will be explained hereinafter being executed by this control circuit 11, a plurality of routes to a destination which has been set are searched out based upon the map data recorded in the DVD-ROM 19, an abridged map for the entirety of each of the routes is generated and displayed upon the display monitor 16.

The current position detection device 14 is an apparatus for detecting the current position of the vehicle, and it may comprise, for example, a vibration gyro 14a which detects the direction of progression of the vehicle, a vehicle speed sensor 14b which detects the vehicle speed, a GPS sensor 14c which detects the GPS signals from GPS satellites, and the like. Based upon the current position of the vehicle which has been detected by this current position detection device 14, the navigation apparatus 1 is able to determine the route search start point when searching for a recommended route.

The image memory 15 temporarily stores image data for display upon the display monitor 16. This image data consists of data for road map drawing and various types of diagrammatical data for image display of an abridged map and the like, and is generated by the control circuit 11, based upon the map data which is recorded on the DVD-ROM 19. An abridged map of the entirety of each of the various routes is displayed upon the display monitor 16, using this image data stored in this image memory 15.

The input device 17 has various types of input switches for the user to perform setting of the destination and the like. The input device 17 may be implemented as an operation panel or a remote controller or the like. By actuating the input device 17 according to screen instructions which are displayed upon the display monitor 16, the user can designate the name of a place or a position upon the map and set it as a destination, and can cause the navigation apparatus 1 to start searching for a route to this destination.

The disk drive 18 reads out map data which is to be used for generating an abridged map from the DVD-ROM 19 which is loaded. It should be understood that although herein, by way of example, the explanation is given in terms of the use of a DVD-ROM, it would also be acceptable to read out the map data from some other recording media other than a DVD-ROM, such as, for example, a CD-ROM or a hard disk or the like. In this map data, there may be included route calculation data which is used for calculating a plurality of routes, route guidance data such as intersection names, road names or the like, which is used for guiding the vehicle to the destination according to a recommended route which has been selected by the user, road data which specifies roads, and the like. In this map data, there may also be included background data or the like which indicates map shapes other than roads, such as shorelines, rivers, railroads, various types of facilities (landmarks) upon the map, and so on.

In such road data, the minimum unit which indicates a road section is termed a link. In other words, each road is made up from a plurality of links which are set for each predetermined road section. It should be understood that the lengths of the road sections set by the links are different; the length of a link is not constant. The points which are connected together by the links are termed nodes, and each of these nodes includes position information (coordinate information). Furthermore, points which are termed shape interpolation points between one node and another may also be set within the links. Each of the shape interpolation points includes position information (coordinate information), just like the nodes. The shapes of the links, in other words the shape of the road, are determined by the position information of these nodes and shape interpolation points. Corresponding to each link described above, a value termed the link cost is set in the route calculation data for indicating the transit time required by the vehicle.

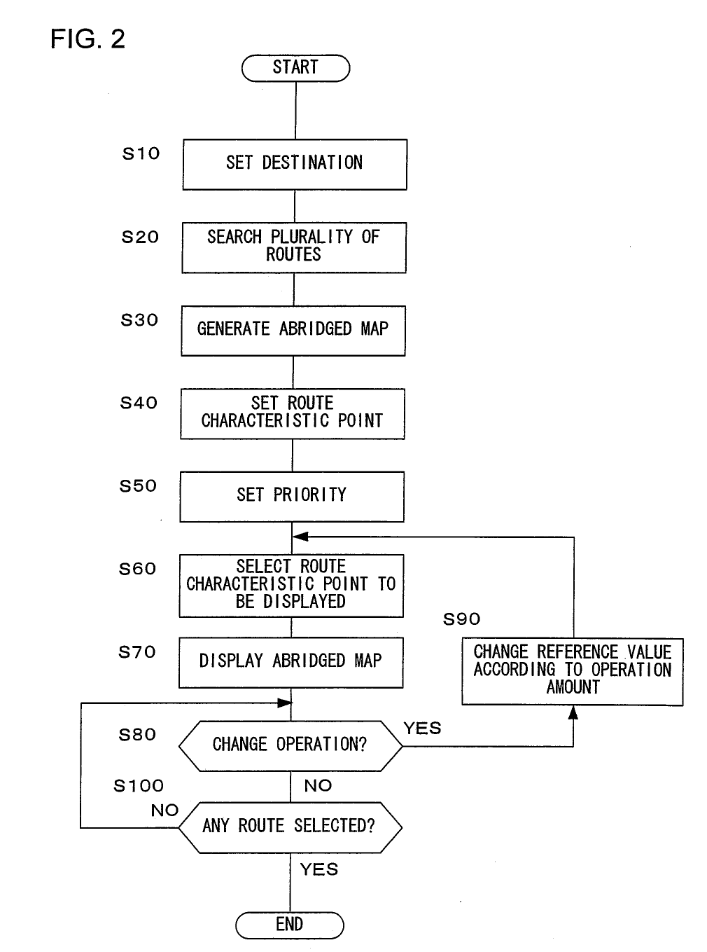

When route search processing is selected by operation of the user to the input device 17 as described above, a route search program is executed by the control circuit 11. This program processing will now be explained in the following using the flow chart shown in FIG. 2. In this route search processing, calculation of route from the current position, which has been detected by the current position detection device 14 as a route search start point, to the destination which has been set is performed according to a predetermined algorithm based upon the route calculation data and a plurality of routes to the destination are obtained. An abridged map of the entirety of each of the routes which have been obtained in this manner is generated based upon the road data, and is displayed upon the display monitor 16.

The flow chart of FIG. 2 will now be explained in the following. In a step S10, the control circuit 11 sets the destination for route searching according to the destination which has been inputted by the user. In a step S20, the control circuit 11 searches out and sets a plurality of routes from the current position of the vehicle, which is the route search point, to the destination which was set in the step S10. At this time, the route calculation is performed according to the predetermined algorithm, based upon the route calculation data, as described above. It should be understood that the current position of the vehicle is obtained by the current position detection device 14 repeatedly at fixed intervals.

Moreover, in the step S20, in order to find a plurality of routes, the control circuit 11 performs the route searching according to various route searching conditions. For example, route searching may be performed according to a route searching condition such as toll road priority, normal road priority, distance priority, or the like, and, by obtaining the most suitable route under each condition, a plurality of routes also may be searched out. Data of the searched routes includes nodes and links, and is stored in the RAM 13 as searched route data. It should be understood that a plurality of routes may also be searched out by looking for routes other than the most suitable route under a single route searching condition. For example, it would be possible to find a plurality of routes with a single route searching condition by taking the route for which the total of the link costs to the destination is the smallest as the most suitable route, and by moreover obtaining a route search result which also includes routes for which the difference of the total link cost with respect to this most suitable route is within a predetermined value.

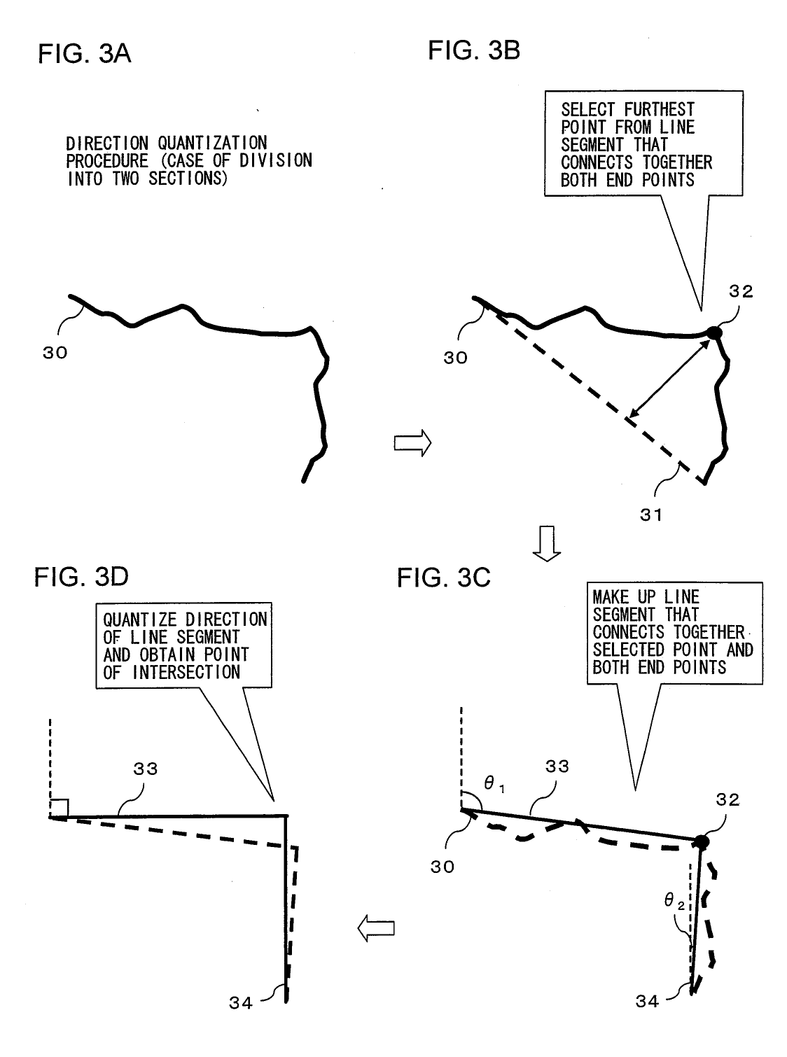

In a step S30, the control circuit 11 generates an abridged map upon each of the routes which was found in the step S20 by simplifying the shape of each of the routes in its entirety, in other words from the current position to the destination. The contents of the processing at this time will be explained hereinafter in detail using FIGS. 3 through 7.

In a step S40, the control circuit 11 sets route characteristic points for each of the routes whose abridged map was generated in the step S30. The route characteristic points are points that show characteristics of each of the routes on an abridged map, for which points upon or along the routes are supposed to be set. The points upon the routes include a confluence point, at which a plurality of routes merge into one road, and a branch point, at which a road branches off. Or, a road category change point, at which a road category of the route changes, a particular intersection, interchange, junction, or the like on the route may be set to a route characteristic point. On the other hand, the points along the routes include various types of facilities located along the routes. Setting this type of points as route characteristic points causes a plurality of route characteristic points to be set for each of the routes.

In a step S50, the control circuit 11 sets priority on each of the route characteristic points set in the step S 40. This priority, a value for determining which of the route characteristic points to be prioritized for display, can be set according to a variety of indices.

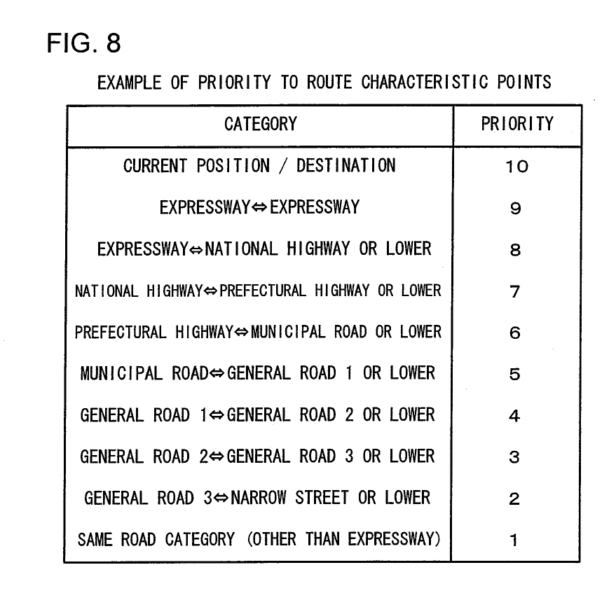

FIG. 8 shows an example of priority to be set according to road categories of routes. In this example, higher priority is given to route characteristic points which include higher road categories of the routes in the following manner: “priority 8 (the third highest)” is given to a characteristic point at which road category of the route changes from expressway to national highway or lower, which includes prefectural highway, municipal road, general road, and narrow street, and vice versa; and “priority 7 (the fourth highest)” is given to a characteristic point at which road category of the route changes from national highway to prefectural highway or lower, which includes municipal road, general road, and narrow street, and vice versa. Thus, priority is given to each of the route characteristic points according to the road category. It should be noted that “priority 9 (the second highest)” is given to a characteristic point on one and the same expressway or a characteristic point at which an expressway is connected to another expressway, each of whose road category of the route remains expressway; “priority 1 (the lowest)” is given to a characteristic point of the same road category other than the category of expressway; “priority 10 (the highest)” is given to current position and destination.

It should be understood that the setting of priority described above is an example and priority on each route characteristic point may be set in another manner. For instance, regardless of whether road categories change, a higher priority may be given to a higher road category according to road categories of route characteristic points. Or, priority may be set based on a positional relationship between a current position, which is a start point of the route, or a destination, which is an end point of the route, and the route characteristic point. At this time, the positional relationship between the start point of the route or the end point of the route and each of the route characteristic points can be expressed by, for example, the distance between the current position or the destination and each of the route characteristic points, estimated time required from the current position to each of the route characteristic points, estimated time required from each of the route characteristic points to the destination, or the like. Priority may be set in various ways other than those described above.

In a step S60, the control circuit 11 selects the route characteristic point to be displayed based upon the priority which was set in the step S50. Here, by selecting from one of the route characteristic points which were set in the step S40 and setting the route characteristic point to be displayed, the control circuit 11 determines the route characteristic point which is to be drawn on an abridged map. This narrows down the route characteristic points to be displayed appropriately so as to allow characteristics of each of the routes to be displayed in an easy-to-read manner, even when a multitude of route characteristic points exist.

In the step S60, the control circuit 11 sets a threshold of priority, for instance, as a reference value for selecting route characteristic points. Specifically, the control circuit 11 selects only the route characteristic points to which priority with a predetermined threshold or more has been set, while eliminating those with priority less than the predetermined threshold from the selection. Or, as a reference value for selecting route characteristic points, the number of route characteristic points to be displayed on an abridged map may be limited. In other words, route characteristic points are selected in descending order of priority as long as the total of the selected route characteristic points is within the predetermined display limit number. In any of the above described manners, the predetermined number of route characteristic points may be selected for display in descending order of priority which was set.

It should be understood that route characteristic points may be selected in a manner other than those explained above. Any method may be applied as long as any of the route characteristic points set in the step S40 can be selected according to the priority set in the step S50.

In a step S70, the control circuit 11 displays the abridged map of each of the routes generated in the step S30 on the display monitor 16, together with the route characteristic points selected for display in the step S60. By this, each of the routes which was set in the step S20 is displayed on the display monitor 16, and, in addition, the route characteristic point selected in the step S60 is displayed being put to each of the routes. At this time, the control circuit 11 displays a departure point mark and a destination mark upon the departure point and upon the destination, respectively.

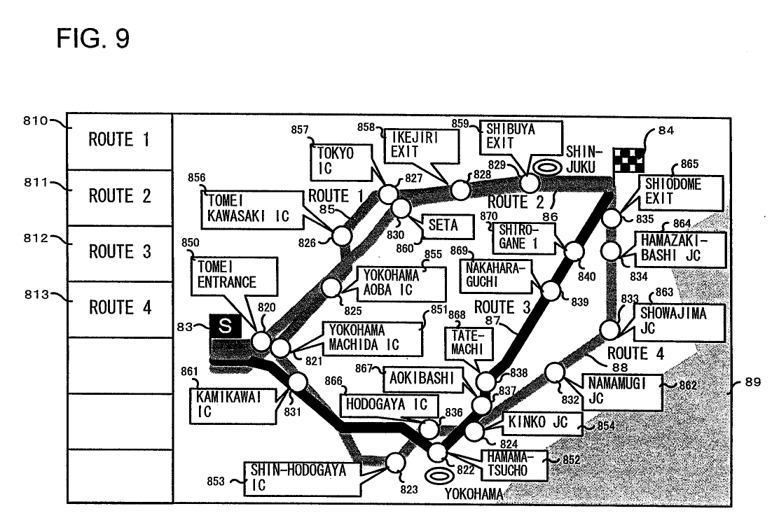

FIGS. 9 through 12 are examples of all-routes display screens displayed on the display monitor 16 by the execution of the step S70. Here, an all-routes display screen means a display screen that displays the entirety of searched routes. Four routes (Routes 1 through 4) searched in the step S20 are displayed between a current position 83 and a destination 84 on those all-routes display screens. It should be understood that the route 1, indicated by the reference symbol 85, is a first searched route; the route 2, indicated by the reference symbol 86, is a second searched route; the route 3, indicated by the reference symbol 87, is a third searched route; and the route 4, indicated by the reference symbol 88, is a fourth searched route. In addition, route selection buttons 810 through 813 for selecting from one of the plurality of the searched routes, and a marine area 89 are displayed.

In the all-routes display screen of FIG. 9, route characteristic point marks 820 through 840 that show each of the route characteristic points selected in the step S50 respectively are displayed in circles so as to make difference among each of the searched routes more comprehensible. And, names 850 through 870 of the route characteristic points to which the route characteristic point marks 820 through 840 are attached, in other words, names of branch points, confluence points, and the like, are displayed.

The route characteristic point mark 820 is displayed as a mark for a branch point at which the first searched route 85, the second searched route 86, and the fourth searched route 88 branch into different routes (National Highway Route No. 246 and Hodogaya Bypass), after going through an identical route (National Highway Route No. 246) and Tomei Entrance intersection. A character string “Tomei Entrance” 850 is displayed in a balloon attached to the route characteristic point mark 820.

The route characteristic point mark 821 is displayed as a mark for a branch point at which the first searched route 85 and the fourth searched route 88 branch into different routes (Tomei Expressway and Hodogaya Bypass), after going through an identical route (Hodogaya Bypass) and Yokohama Machida Interchange. A character string “Yokohama Machida IC” 851 is displayed in a balloon attached to the route characteristic point mark 821.

The route characteristic point mark 822 is displayed as a mark for a change point, an intersection of Hamamatsucho, at which a road through which the third searched route 87 goes changes from Hachioji Kaido Road into National Highway Route No. 1. A character string “Hamamatsucho” 852 is displayed in a balloon attached to the route characteristic point mark 822.

The route characteristic point mark 823 is displayed as a mark for a change point, Shin-Hodogaya Interchange, at which a road through which the fourth searched route 88 goes changes from Hodogaya Bypass into Yokohama Shindo Bypass. A character string “Shin-Hodogaya IC” 853 is displayed in a balloon attached to the route characteristic point mark 823.

The route characteristic point mark 824 is displayed as a mark for a change point, Kinko Junction, at which a road through which the fourth searched route 88 goes changes from Metropolitan Expressway Route K2 Mitsuzawa Line into Metropolitan Expressway Route K1 Yokohane Line. A character string “Kinko JC” 854 is displayed in a balloon attached to the route characteristic point mark 824.

In the same manner as explained above, route characteristic point marks 825 through 840 are displayed for branch points or confluence points of routes, road categories change-points, major intersections, interchanges, junctions, or the like. Character strings 855 through 870 are displayed in balloons attached to the route characteristic point marks 825 through 840 respectively. The detailed explanation thereof will herein be omitted. It should be understood that in the descriptions below each of the reference symbols 820 through 840 for each of the route characteristic point marks will be used as those for point names of corresponding points.

The all-routes display screen of FIG. 9 described above does not include any route characteristic point mark for facilities along the routes. However, all-routes display screens may include route characteristic point marks for facilities. Route characteristic point marks are displayed on positions of landmarks or the like along any of the routes, and the names of the landmarks can be expressed in character strings.

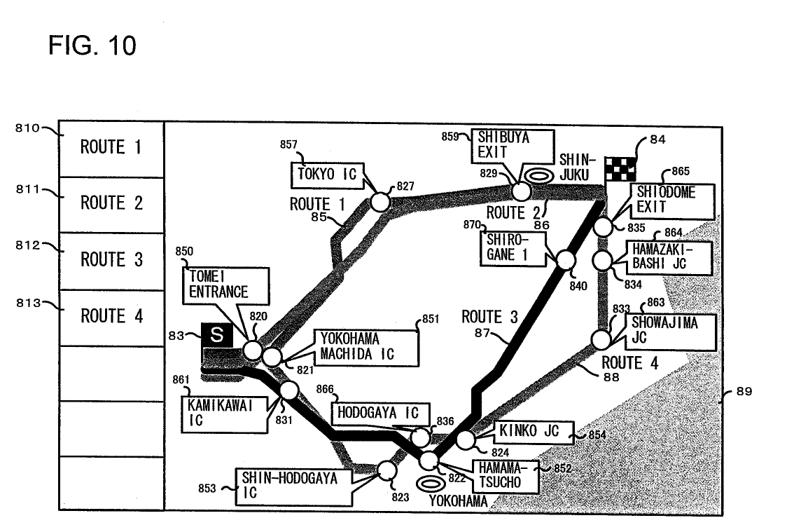

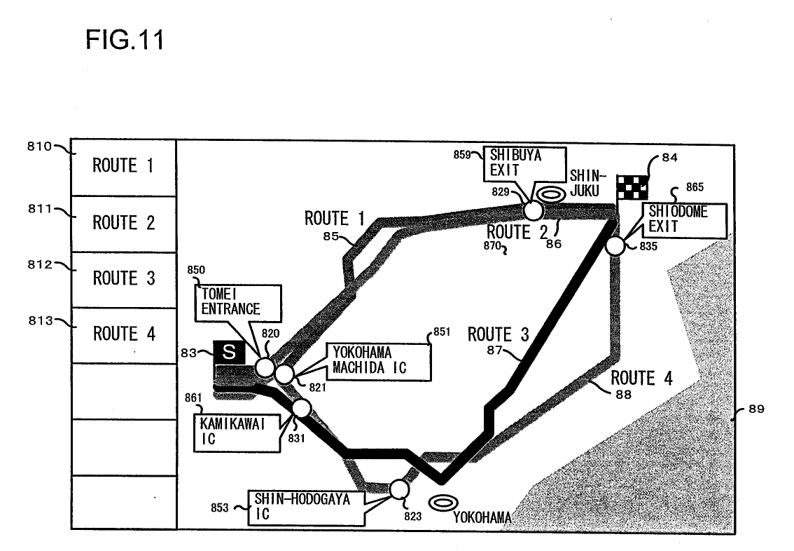

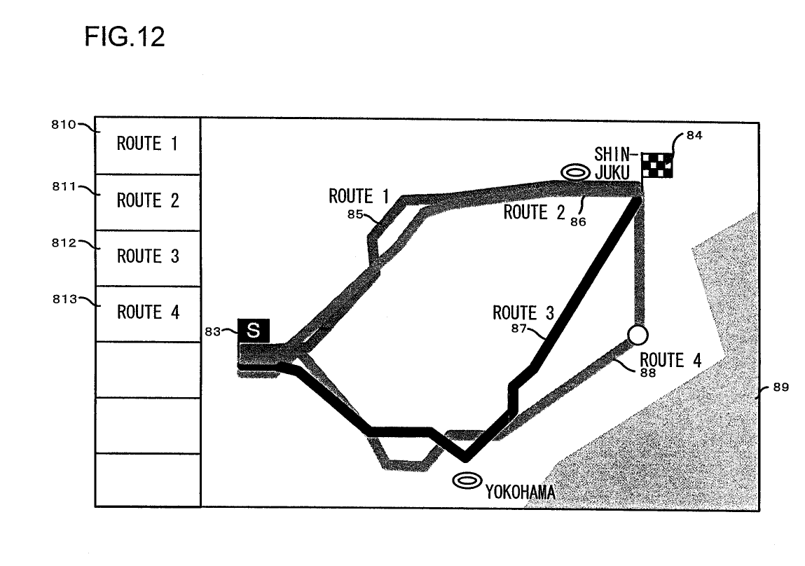

On the other hand, an all-routes display screen of FIG. 10 includes only some, not all, of the route characteristic points displayed in FIG. 9. An all-routes display screen of FIG. 11 includes the route characteristic points smaller than in FIG. 10 in number. An all-routes display screen of FIG. 12 includes none of the route characteristic points. The difference in the number of the route characteristic points displayed in all-routes display screens results from processing in steps S80 and S90 described hereinafter.

In the step S80, the control circuit 11 determines whether or not the user has performed a predetermined change operation on the input device 17. Here, a change operation means an operation for changing route characteristic points to be displayed, and is, as described below, implemented by a rotating operation or a sliding operation on the input device 17 by the user. If the change operation is implemented, the flow of control proceeds to a step S90, while if it is not, then the flow of control proceeds to a step S100.

In the step S90, the control circuit 11 changes the reference value for selecting characteristic points in the step S60, according to the operation amount of the change operation detected in the step S80. Specifically, if the threshold of priority was set in the step S60 as a reference value for selecting route characteristic points as described above, the control circuit 11 changes the threshold in the step S90 according to an operation by the user. If the limit of the number of route characteristic points to be displayed was set on an abridged map in the step S60 as a reference value for selecting route characteristic points as described above, the control circuit 11 changes the limit in the step S90 according to the operation of the user. After changing the reference value in this manner, the control circuit 11 returns the flow of control to the step S60, and selects route characteristic points to be displayed in the step S60 based on the changed reference value.

It should be understood that the navigation apparatus 1 is provided with, as the input device 17, for instance, a dial operation member that can be operated in a rotating manner. When the user implements a rotating operation on this operation member, the control circuit 11 changes continuously the threshold of priority or the limit of the number of route characteristic points to be displayed as described above, according to the operation amount. The navigation apparatus 1 may be provided with, as the input device 17, an operation member that can be operated up and down or left and right in a sliding manner. When the user implements a sliding operation on this operation member, the control circuit 11 changes continuously the threshold of priority or the limit of the number of route characteristic points to be displayed as described above, according to the operation amount. By either of the above manners, the user is allowed to change the reference value for selecting route characteristic points to be displayed on the abridged map into any value with an easy operation. It should be understood that an operation member may be realized using a touch screen.

In the case where the flow of control proceeds from the step S80 to the step S100, in the step S100 the control circuit 11 makes a decision whether or not any one of the plurality of the routes on the abridged map which was displayed in the step S70 is selected. Here, it would also be acceptable to direct the user to select from one of the routes. When the user selects any one of the routes by operating the input device 17, the control circuit 11 terminates the flow chart of FIG. 2 and sets the selected route as a recommended route. Then, the control circuit 11 displays a road map of the surroundings of the current position and indicates the recommended route on the map. Then, the control circuit 11 directs and guides the vehicle to the destination according to the recommended route. It should be understood that at this time, as a road map of the surroundings of the current position, either a normal map or an abridged map may be displayed. At this time, an abridged map may be generated by the same procedure as that of the flow chart of FIG. 2. On the other hand, when the user selects none of the routes in the step S100, the control circuit 11 returns the flow of control to the step S80.

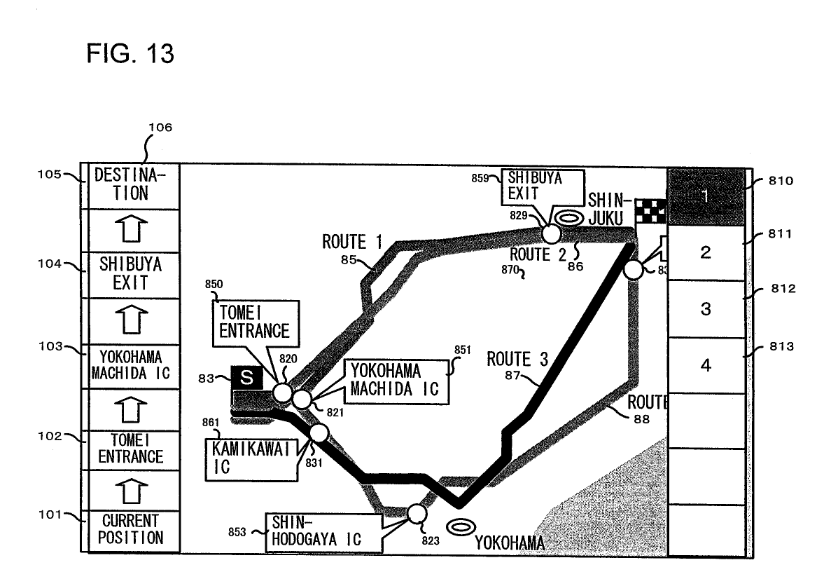

In any one of the all-routes display screen shown in FIGS. 9 through 12, when any one of the route selection buttons 810 through 813 is selected by the user operating the input device 17, the current position (departure point) of the searched route which was selected, the point names with the route characteristic point marks displayed, and the destination are extracted. In FIG. 11, for instance, when the route selection button 810 is selected, the current position, waypoints of the route between the current position and the destination, and the destination are displayed in an upward order, as FIG. 13 shows, in a waypoint display area 106 provided on the left side of the screen on which a plurality of the searched routes are displayed. For the waypoints, the point names with the route characteristic point marks displayed are displayed.

In the waypoint display area 106 of FIG. 13, a current position button 101 and a destination button 105 are displayed at the bottom and at the top respectively. An up-arrow is displayed above the current position button 101, and a waypoint button 102 that indicates Tomei Entrance is displayed above the up-arrow. An up-arrow is displayed above the button 102, and a waypoint button 103 that indicates Yokohama Machida Interchange is displayed above the up-arrow above the button 102. An up-arrow is displayed above the button 103, and a waypoint button 104 that indicates Shibuya Exit is displayed above the up-arrow above the button 103. The route selection buttons 810 through 813 are shifted and displayed to the right side of the screen on which the plurality of the searched routes are displayed. It should be understood that change of the color of the route selection button 810 indicates that the route selection button 810 is under selection.

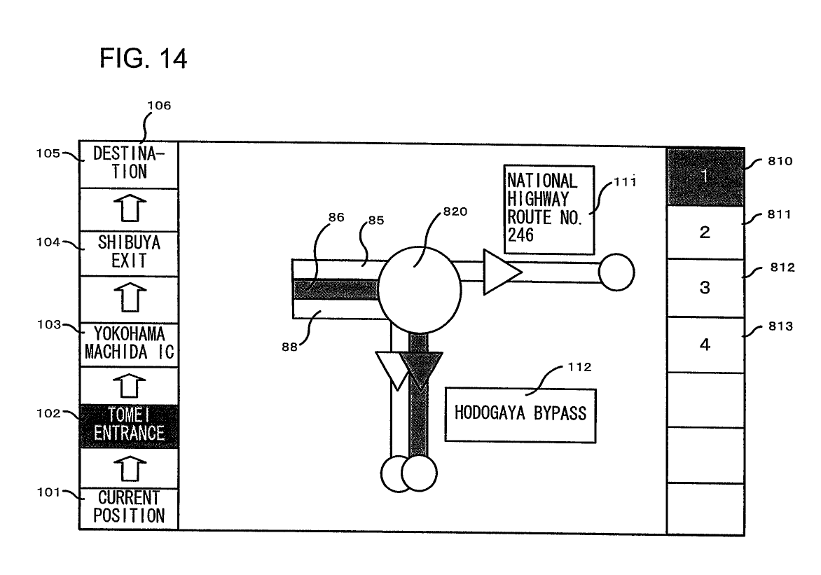

The current position button 101, the waypoint buttons, 102 through 104, and the destination button 105 can be selected using the input device 17. When the user selects any one of the buttons, the searched route around the point is zoomed in and displayed on the display monitor 16 in detail. In other words, when the user selects any one of the buttons 101 through 105, a direction for display the surroundings of the branch point or the change point in detail is sent to the control circuit 11. Then, the detail of the surroundings of the point is displayed on the display monitor 16. When the waypoint button 102 that indicates Tomei Entrance is selected, for example, as FIG. 14 shows, the searched route around Tomei Entrance intersection, the selected point, is zoomed in and displayed. On the screen where the searched route is zoomed in and displayed, the route characteristic point mark 820 and the searched routes 85, 86, and 88, each of which passes through the branch point to which the route characteristic point mark 820 is attached, are displayed. In addition, the names of roads 111 and 112 through which the vehicle is supposed to go after passing through the branch point to which the route characteristic point mark 820 was attached.

Next, the details of the abridged map generation procedure which is executed in the step S30 will be explained. In this abridged map generation procedure, the road shape of each of the routes is simplified by executing a procedure which is termed a direction quantization procedure. The control circuit 11 thus generates an abridged map of each of the routes. This direction quantization procedure will now be explained in the following.

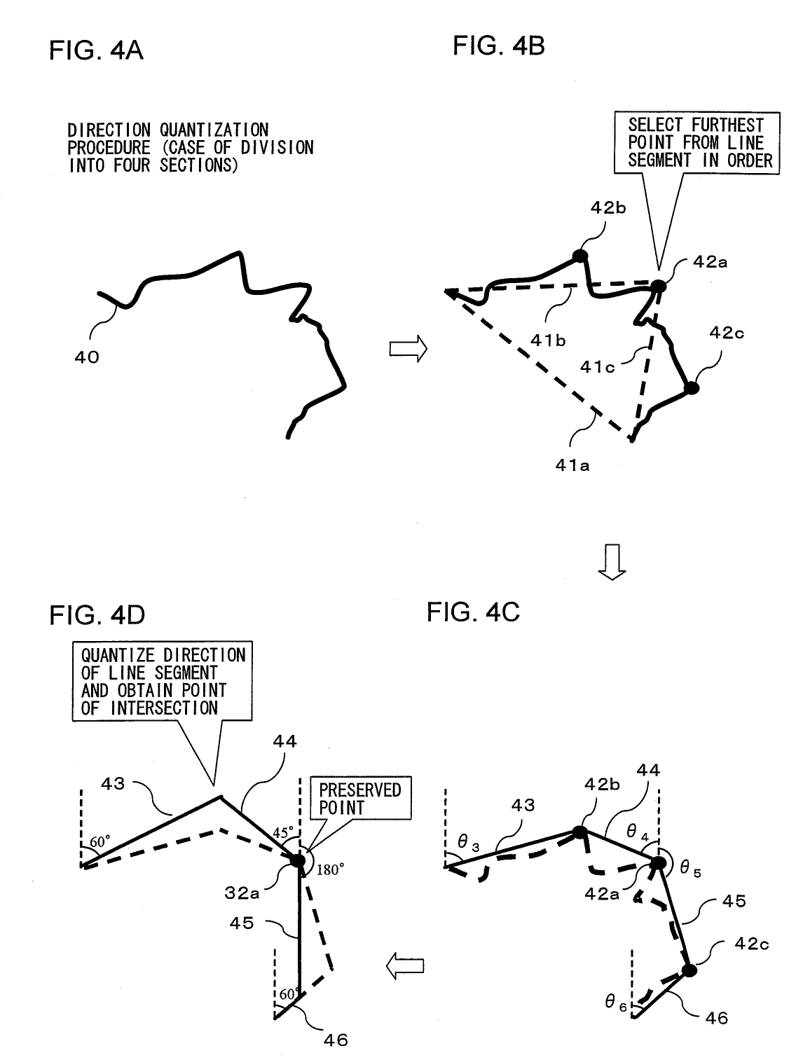

In this direction quantization procedure, simplification of the road shapes is performed by dividing the links of each route into respective predetermined numbers of sections. Each of FIGS. 3A, 3B, 3C, and 3D, and FIGS. 4A, 4B, 4C, and 4D is a detailed explanatory figure for explaining the details of this direction quantization procedure. In FIGS. 3A through 3D, the details of the direction quantization procedure are shown for the case in which the number of link sections is two (division into two sections); while, in FIGS. 4A through 4D, the details of the direction quantization procedure are shown for the case in which the number of link sections is four (division into four sections). In the following, first, explanation will be provided for the case of division into two sections, shown in FIGS. 3A through 3D.

The reference symbol 30 in FIG. 3A designates, by way of example, one of the links included in a route which has been searched out. For this link 30, as shown in FIG. 3B, the point 32 upon this link 30 which is furthest from the line segment 31 which connects together both its end points is selected. It should be understood that the point 32 which is selected here corresponds to the node or the shape interpolation point previously described.

When the point 32 as described above has been obtained, next, line segments 33 and 34 are established which connect, respectively, the two end points of the link 30 with the point 32, as shown in FIG. 3C. The angles respectively formed between these line segments 33 and 34 and reference lines are defined as θ1 and θ2 respectively. It should be understood that, here, by reference lines are meant lines which extend from both the end points of the link 30 in a direction which is determined in advance (for example, the true north direction). As shown in FIG. 3C, the angle of the portion which is sandwiched between the reference line from one end point and the line segment 33 is termed θ1. Moreover, the angle of the portion which is sandwiched between the reference line from the other end point and the line segment 34 is termed θ2.

After having established the line segments 33 and 34 which connect the point 32 and the two end points of the link 30 respectively in the above described manner, next, as shown in FIG. 3D, the directions of these line segments 33 and 34 are each quantized. Here, quantization of these directions means that each of the line segments 33 and 34 is rotated around its end point as a center, so that the above described angles θ1 and θ2 become integer multiples of some unit angle which is set in advance. In other words, the values of θ1 and θ2 are revised by rotating the respective line segments 33 and 34, so that θ1=m·Δθ and θ2=n·Δθ (where n and m are integers). The values of m and n at this time are set so that the θ1 and θ2 after revision which are calculated according to the above described equation are as close as possible to their respective original values.

When the directions of the line segments 33 and 34 are both quantized as explained above, the angles θ1 and θ2 which the line segments 33 and 34 make with the reference lines are revised so as to be multiples of the unit angle Δθ. It should be understood that, in FIG. 3D, Δθ=15°. And in the figure an example is shown in which, for θ1, m is set to be equal to 6, so that the angle after revision becomes 90°, while, for θ2, n is set to be equal to 0, that the angle after revision becomes 0°.

After having quantized the directions of each of the line segments 33 and 34 in this manner, next, the point of intersection when both of the line segments 33 and 34 are prolonged is obtained. And the length of each of the line segments 33 and 34 is revised, so as to connect this point of intersection with both of the end points, as shown in FIG. 3D.

As has been explained above, the direction quantization procedure for the case of division of the link 30 into two sections is performed by obtaining the line segments 33 and 34, and by quantizing their directions as well as adjusting their lengths. By using these line segments 33 and 34 instead of the link 30, it is possible to display the shape of the link 30 in a simplified manner. Since, at this time, the shape of the link 30 is simplified in the state in which the positions of both the end points of the link 30 are fixed, thus no influence is exerted upon the positions of the adjacent links. Accordingly it is possible easily to simplify the shape of a road with maintaining the overall positional relationships of the route, by simplifying each of the link shapes of the route by using this direction quantization procedure.

Next, the case of division into four sections will be explained. In FIG. 4A, just as in FIG. 3A, the reference symbol 40 denotes, as an example, one link included in a route which has been searched out. For this link 40, first, as shown in FIG. 4B, the point 42a upon the link 40 which is furthest from the line segment 41a which joins together both the end points of this link 40 is selected. Next, the two line segments 41b and 41c which respectively connect together this point 42a and the two end points of the link 40 are established, and the points 42b and 42c upon the link 40 which are respectively positioned furthest away from these line segments 41b and 41c are selected. It should be understood that the points 42a through 42c which are selected here all correspond to the previously described nodes or shape interpolation points, just as in the case of division into two sections.

After having obtained the points 42a through 42c as described above, next, as shown in FIG. 4C, just as in the case of division into two sections, the line segments 43, 44, 45, and 46 are established which connect together the end points of the link 40 and the points 42a through 42c, in the irrespective order. The angles respectively formed between these line segments 43 through 46 and reference lines are expressed as θ3, θ4, θ5, and θ6 respectively. It should be understood that the reference lines at this time are not only determined at both the endpoints of the link 40, but rather are also determined at the point 42a which was initially selected, and which is positioned at the center of the points 42a through 42c.

After having established the line segments 43 through 46 as described above, next, as shown in FIG. 4D, the direction of each of these line segments is quantized. At this time, taking the point 42a as a preserved point, the line segments 44 and 45 are each rotated about this preserved point 42a as a center. It should be understood that, for the line segments 43 and 46, they are each rotated about the end point as a center, in the same manner as in the case of division into two sections. Here an example is shown in which Δθ=15° is set in advance, and, after revision, the angles θ3, θ4, θ5, and θ6 have become, respectively, 60°, 45°, 180°, and 60°.

After having quantized the direction of each of the line segments 43 through 46 in this manner, next, the points of intersection are obtained when the line segments 43 and 44 have both been prolonged, and when the line segments 45 and 46 have both been prolonged. And, as shown in FIG. 4D, the lengths of the line segments 43 through 46 are each revised, so that each of the points of intersection is connected with each of the end points or the preserved point 42a.

As has been explained above, the direction quantization procedure for division of the link 30 into four sections is performed by obtaining the line segments 43 through 46, and by quantizing their directions as well as adjusting their lengths. By using these line segments 43 through 46 instead of the link 40, it is possible to display the shape of the link 40 in a simplified manner. At this time, the shape of the link 40 is simplified in a state in which, in addition to the positions of both the end points of the link 40, also the position of the preserved point 42a is also fixed. Accordingly, it is possible to simplify the shape of a road appropriately while maintaining its overall positional relationships, even for a route which is made up from links of a complicated shape.

It should be understood that although, in the above, the direction quantization procedure has been explained for the cases of division into two sections and division into four sections, it would also be possible to perform this direction quantization procedure in the same manner for division into any other number of sections. For example, in a case of division into eight sections, first, just as in the case of division into four sections, the furthest point from the line segment which connects together both end points of the link, and the furthest two points from each of the two line segments which connect together that point and the two endpoints, are selected. After this, further, the furthest four points from each of the four line segments which connect between these three points with the addition of both the endpoints are selected. By doing this, eight line segments are obtained which connect in order between the total of seven points and the two end points which have been selected, and it is possible to perform a direction quantization procedure by performing quantization of the directions and adjustment of the lengths of these line segments, in the manner previously described.

How many sections should be employed for the direction quantization procedure may be set in advance, or may also be decided according to the shapes of the links. For example, when proceeding to select the furthest point from each line segment which joins between both end points or the points which have been selected up till this time in order as described above (the procedure explained in FIGS. 3B and 4B), points may be selected in order until the distance from each of the line segments to the furthest point becomes less than a predetermined value. If this is done, it is possible to determine upon the number of sections for the direction quantization procedure according to the shapes of the links.

It is possible to generate an abridged map by simplifying the road shape of each route by performing a direction quantization procedure as has been explained above upon all of the links of each route in order. It should be understood that it would also be acceptable to execute a direction quantization procedure collectively for some of the links, instead of executing that for each of the links in order.

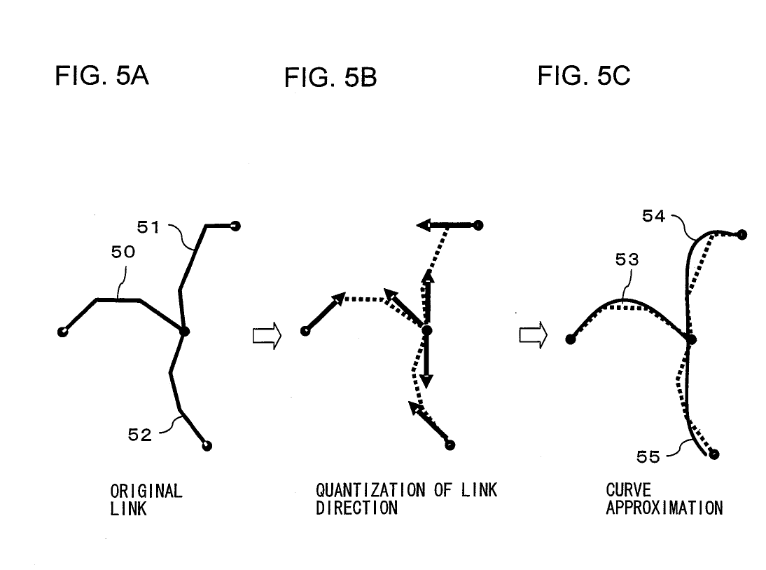

Or, in the abridged map generation procedure of the step S30, it is also possible to simplify the road shape of each route, without executing the above described direction quantization procedure. In this connection, a method of simplifying the road shapes of the routes by approximating the shape of each link with a curve will now be explained with reference to FIG. 5.

In FIG. 5A, by way of example, links 50, 51, and 52 are shown as one part of the links included in a route which has been searched out. For these links 50 through 52, first, as shown in FIG. 5B, the link directions quantized at both of the end points of each link are obtained. Here, in the same manner as when performing quantization of the directions of each line segment in the previously described quantization procedure, the link direction is obtained which is the integral multiple of a unit angle closest to the original angle. As a result, link directions at each end point are obtained as shown by the arrow signs in FIG. 5B.

Next, as shown in FIG. 5C, the shape of each of the links is approximated by a curve, by obtaining curves 53, 54, and 55 which connect between its end points. At this time, the shape of each of the curves 53˜55 is determined so that the direction of the tangent line in the vicinity of the end points of each curve agrees with the above described quantized link direction. It should be understood that although, as a method for obtaining this type of curve, for example, spline approximation using spline functions or the like is available, the detailed explanation thereof will herein be omitted.

It is possible to generate an abridged map in which the road shape of each route is simplified by proceeding with the execution of procedures like those explained above for all the links of each route in order, and by displaying the road shapes using the curves which have been obtained. At this time as well, in the same way as in the case of the direction quantization procedure, the shape of each link is simplified in a state in which the positions of both of the end points of that link are fixed. Accordingly, in this case as well, it is possible to simplify the road shape of each route in a simple manner, while maintaining its overall positional relationships.

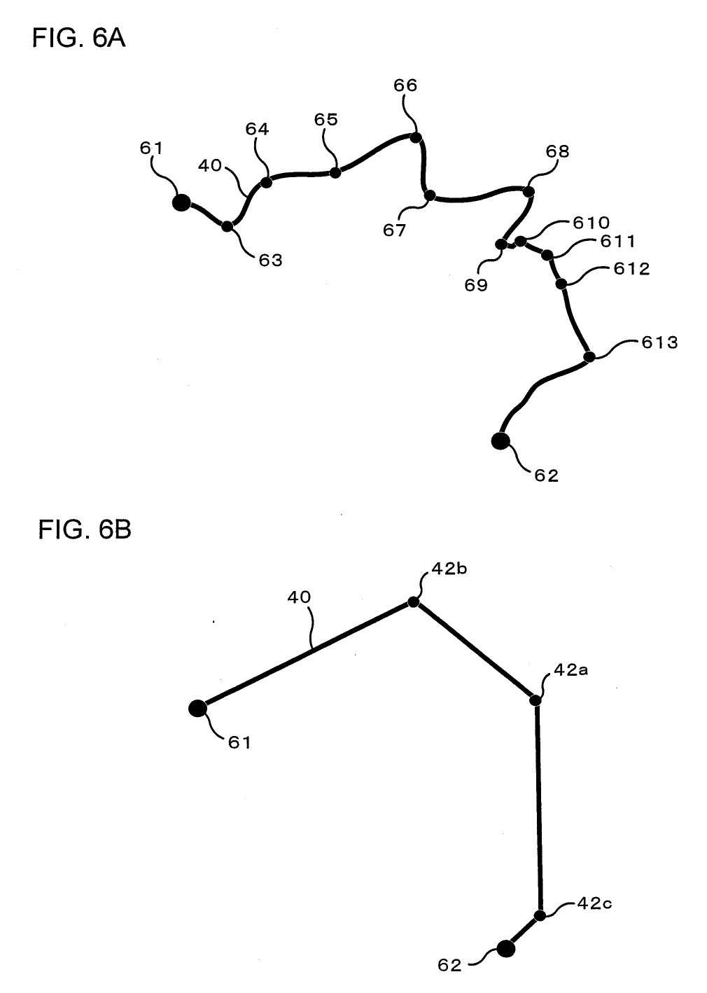

The route for which the direction quantization procedure was performed is stored in the RAM 13. Next, data formats for the routes to be stored in the RAM 13 will be explained, with an example of the link on which the direction quantization procedure for the case of division into four sections was performed. Here, it will be supposed that the link 40 makes up a part of a route. FIG. 6A shows nodes 61 and 62 and shape interpolation points 64 through 69 and 610 through 613 of the link 40 before the direction quantization procedure is performed. FIG. 6B shows the nodes 61 and 62 and the shape interpolation points 42a through 42c of the link 40 after the direction quantization procedure is performed. The link 40 of FIG. 6B after the direction quantization procedure is performed has three shape interpolation points 42a through 42c, on the other hand, the link 40 of FIG. 6A before the direction quantization procedure is performed has eleven shape interpolation points 64 through 69 and 610 through 613. Thus, a direction quantization procedure decreases shape interpolation points in number and culls them.

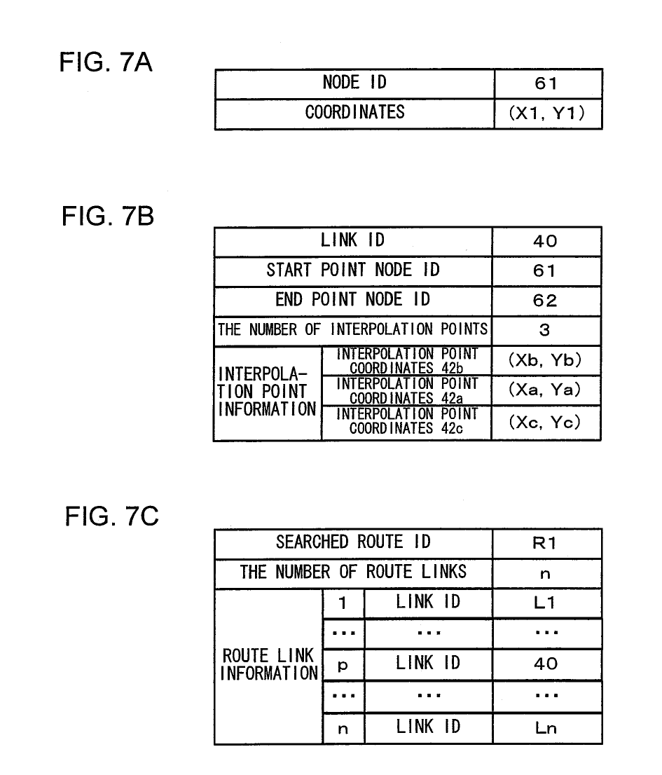

The link 40, on which the direction quantization procedure was performed, is stored in the RAM 13 in a node data format shown in FIG. 7A, a link data format shown in FIG. 7B, and a route data format shown in FIG. 7C. The node data format shown in FIG. 7A is a format in which the node ID of each of the nodes that are stored in the DVD-ROM 19 as map data and the coordinates of the node after the direction quantization procedure is performed are stored. In FIG. 7A, the reference symbol “61” is stored in the RAM 13 as a node ID of the node 61 in FIGS. 6A and 6B. And, the coordinates of the node 61 (X1, Y1) is stored in the RAM 13.

The link data format shown in FIG. 7B is a format in which the reference symbol “40” as a link ID of each of the links stored in the DVD-ROM 19 as map data and the reference symbols “61” and “62” as the node IDs of a start point node 61 and an endpoint node 62 respectively of the link are stored. In addition, in the link format, the number of the shape interpolation points 42a through 42c on the link 40 and their coordinates (Xb, Yb), (Xa, Ya), and (Xc, Yc) are also stored.

The route data format shown in FIG. 7C is a format in which an identification symbol (route ID) is given to each of the routes on which the direction quantization procedure was performed, and, for each of the route IDs, the number of the links that make up each of the routes and the link ID are stored. Here, the route ID of the route in which the link 40 is included is R1. In the RAM 13, R1, which is the route ID of the route R1, n, which is the number of the links that make up the route, and L1 through Ln, which are IDs of each of the links that make up the route R1 are stored. If a plurality of searched routes are displayed, the link IDs which have been stored in the route data format of each of the searched routes are supposed to be referred. As a result, it will be understood that, if the same link ID exists, the searched routes with the same link ID overlap with each other at the position of the link with the same link ID. In other words, it will be understood that the searched routes with the same link ID mutually go through the same route partly.

According to the embodiment explained above, the following operational benefits are obtained.
(1) By the processing of the control circuit 11, the navigation apparatus 1 sets a plurality of routes (step S20) and a plurality of route characteristic points for each of the routes which have been set (step S40). The navigation apparatus 1 sets priority for each of the route characteristic points which have been set in this manner (step S50), and selects any one of the route characteristic points based on the priority which has been set (step S60). The navigation apparatus 1 displays the plurality of the routes which were set in the step S20 on the display monitor 16, and displays the route characteristic points which were selected in the step S60 being put to each of the routes (step S70). Since this is done, even if a multitude of route characteristic points, which show characteristics of routes, exist, it is possible to display characteristics of each of the route in an easy-to-read manner.
(2) In the step S60, the control circuit 11 selects the route characteristic points to which priority with a predetermined threshold or more has been set. Or, the control circuit 11 selects route characteristic points in descending order of priority as long as the sum of the selected route characteristic points is within the predetermined limit of the number of the route characteristic points to be displayed. Since this is done, it is possible to appropriately select route characteristic points based upon the priority which has been set.
   (3) The control circuit 11 changes, according to an operation by the user, the threshold or the limit of the number of route characteristic points to be displayed that was used at selecting route characteristic points in the step S60 (step S90). The navigation apparatus 1 is provided with, as the input device 17, an operation member that can be operated in a rotating or a sliding manner. The control circuit 11 changes continuously the above described threshold of priority or the above described limit of the number of route characteristic points to be displayed, according to the operation amount on the operation member by the user. Since this is done, it is possible for the user to change the threshold or the limit of the number of route characteristic points for display which is used as a reference value for selecting route characteristic points to be displayed into any value with an easy operation, so as to change the number of the route characteristic points to be displayed on an all-routes display screen.
(4) In the step S40, the control circuit 11 sets points upon or along the routes as route characteristic points. The control circuit 11 sets, among the points upon the routes, for instance, one or more points such as a branch point, at which a road branches into a plurality of routes, a confluence point, at which a plurality of routes merge into one road, a road category change point, at which a road category of the route changes, an intersection on the route, or an interchange on the route, as route characteristic points. The control circuit 11 sets, on the other hand, among the points along the routes, facilities located along the routes as route characteristic points. Since this is done, it is possible to set points that make route characteristics comprehensible to the user as route characteristic points.
(5) In the step S50, the control circuit 11 sets priority based on a road category of the route at the route characteristic points or based on a positional relationship between a start point or an end point of the route and the route characteristic points. Since this is done, it is possible to set priority appropriately.
(6) In the step S70, the control circuit 11 displays an abridged map, in which the shape of routes is simplified, on the display monitor 16 so as to display the plurality of the routes which were set in the step S20. Since this is done, it is possible to display descriptions or characteristics of each of the routes in an easy-to-understand manner.

It should be understood that although, in the above described embodiment, an example was explained in which a plurality of routes are searched, the present invention is not limited to the example. The present invention may also be applied in the case of searching one route and displaying route characteristic points to the route. And, although in the above description it is arranged to display whole route by an abridged map, in which the road shape is simplified, the present invention may also be applied in the case of displaying whole route by a normal map in which road shape is not simplified or in the case of displaying only a part of the route. In other words, as long as setting a single or a plurality of routes, displaying whole or part of the route, and displaying route characteristic points put to the route, the present invention may also be applied in any map representation.

Although, in the above described embodiment, the explanation is made in terms of an example in which the map data is read out from a storage media such as a DVD-ROM or the like by the navigation apparatus, and an abridged map is generated, the present invention is not limited by these details. For example, it would also be possible to apply the present invention to a communicating navigation apparatus or the like which downloads the map data from an information distribution center, using wireless communication with a portable telephone or the like. In this case, an on-vehicle navigation apparatus may send a current position and a destination to an information distribution center and the information distribution center may perform the procedure of the steps S20 through S60 of FIG. 2, with the result thereof being outputted from the information distribution center as a signal which is distributed to the navigation apparatus.

The above described embodiments and variations are examples, and various modifications can be made without departing from the features of the invention.

What is claimed is:

1. A navigation apparatus, comprising:
a route setting unit that sets a route;
a route characteristic point setting unit that sets a plurality of route characteristic points to the route set by the route setting unit;
a priority setting unit that sets priority to each of the route characteristic points set by the route characteristic point setting unit;
a selecting unit that selects any of the route characteristic points based upon the priority set by the priority setting unit; and
a display control unit that displays the route and the route characteristic point selected by the selecting unit on a display monitor.

2. A navigation apparatus according to claim 1, wherein:
the selecting unit selects a route characteristic point to which priority with a predetermined threshold or higher is set.

3. A navigation apparatus according to claim 2, further comprising:
a changing unit that changes the threshold according to an operation by a user.

4. A navigation apparatus according to claim 3, further comprising:
an operation member that can be operated in a rotating or a sliding manner; wherein
the changing unit changes the threshold according to an operation amount of the operation member by the user.

5. A navigation apparatus according to claim 1, wherein:
the selecting unit selects route characteristic points in descending order of priority as long as the total number of selected route characteristic points is within a predetermined display limit number.

6. A navigation apparatus according to claim 5, further comprising:
a changing unit that changes the display limit number according to an operation by a user.

7. A navigation apparatus according to claim 6, further comprising:
an operation member that can be operated in a rotating or a sliding manner; wherein
the changing unit changes the display limit number according to an operation amount of the operation member by the user.

8. A navigation apparatus according to claim 1, wherein:
the route characteristic point setting unit sets points upon the route or points along the route as the route characteristic points.

9. A navigation apparatus according to claim 8, wherein:
the route setting unit sets a plurality of routes; and
the route characteristic point setting unit sets, among the points upon the routes, at least one of a branch point at which a road branches into a plurality of the routes, a confluence point at which a plurality of the routes merge into one road, a road category change point at which a road category of the route changes, an intersection on the route, and an interchange on the route, as the route characteristic point.

10. A navigation apparatus according to claim 8, wherein:
the route characteristic point setting unit sets, among the points along the route, a facility located along the route as the route characteristic point.

11. A navigation apparatus according to claim 1, wherein:
the priority setting unit sets the priority based upon a road category of the route at the route characteristic point or based upon a positional relationship between a start point or an end point of the route and the route characteristic point.

12. A navigation apparatus according to claim 1, wherein:
the display control unit displays an abridged map in which a shape of the route is simplified on the display monitor.

13. A navigation apparatus, comprising:
a route setting unit that sets a route;
a route characteristic point setting unit that sets a facility located along the route as a route characteristic point to the route; and
a display control unit that displays the route and the route characteristic point on a display monitor.
